(19) United States
(12) Patent Application Publication
(10) Pub. No.: US 2008/0302262 A1
(43) Pub. Date: Dec. 11, 2008

(54) DIRECT PRINTING DEVICE

(76) Inventors: Yariv Y. Pinto, Petach Tikva (IL); Haim Chayet, Nes Niona (IL)

Correspondence Address: David A. Novais;Patent Legal Staff, Eastman Kodak Company, 343 State Street, Rochester, NY, 14650-2201, US

(21) Appl. No.: 11/759,374

(22) Filed: Jun. 7, 2007

(51) Int. Cl. B41F 7/00

(52) U.S. Cl. 101/467; 101/451

(57) ABSTRACT

A printing apparatus for direct printing comprises an image bearing printing surface (10) that comprises a plurality of cells (12) for storing ink; a means for loading ink into the cells; a means for imaging direction on a substrate (55) by affecting ink properties in a first group of cells to form ink affinity to the substrate; a means for unloading ink by affecting ink properties in a second group of cells to nullify ink affinity to the substrate; and a means for collecting the unloaded ink from the second group of cells.

### FIELD OF THE INVENTION

This invention relates in general to a direct printing device and methods, and in particular to a printing device that changes ink properties to change ink affinity for a substrate.

### BACKGROUND OF THE INVENTION

In current printing technology the final image is conveyed to a substrate by transferring ink from an image bearing printing surface to the substrate. The image bearing surface generally picks up ink only on the ‘image’ areas, the areas that correspond on the substrate to be inked. The print on the substrate is produced by transferring ink directly or indirectly from an inked-up image bearing surface to the substrate. An example of this technology is a printing plate wherein certain areas of the plate are hydrophobic or hydrophilic.

In conventional printing systems, the image bearing surface picks up liquid or paste ink, typically from an ink reservoir. The means by which the surface transfers ink to the ‘image’ areas depends upon the particular technology. Printing plates will be used in flexography and offset lithography, whereas specially made cylinders are used in gravure printing. The ink is then transferred to another surface, be it the final product substrate, such as printed paper, or an intermediate medium such as a rubber blanket.

In digital printing systems, ink is transferred to the substrate in various ways for example, ink jet printing. Digital printing has an advantage over conventional print in its ability to handle variable information. This allows the printer to tailor each print differently. The main drawbacks of digital printing are that it is, in general, significantly more expensive and time consuming than conventional printing processes.

Surface energy quantifies the disruption of bonds when a surface is formed. Surfaces are intrinsically energetically less favorable than the bulk of the material and the difference in energy between the bulk and the surface constitutes the surface energy. When a liquid comes in contact with a solid surface, wetting of the surface by the liquid can occur. If complete wetting does not take place, a droplet of liquid will form on the surface. This droplet will have a contact angle with the surface (the angle at which a droplet meets the solid surface), which is a function of the surface energies of the system. In fact, the contact angle is used many times to quantify the surface energies of liquids and solids in the following manner:

Young's equation:

γ_{SL}+γ_{LV} cos θ=γ_{SV} (1)

Where γ_{SL}, γ_{LV} and γ_{SV} are an interfacial free energy (or surface tension) of solid-liquid, liquid-vapor and solid-vapor interfaces, respectively.

Using the free energy of the work adhesion W_{SL}, Dupre equation is,

γ_{SL}=γ_{S}+γ_{L}−W_{SL}. (2)

Combining (1) and (2) yields the Young-Dupre equation,

γ_{L}(1+cos θ)=W_{SL}. (3)

The transfer of ink to the substrate can be controlled by controlling the adhesion of the fluid ink to the impression surface. Wetting of a solid surface by a liquid depends on the relative surface energies of the liquid and the solid substrate.

When a liquid has a higher surface energy than the solid, the liquid will form a droplet which will not spread on the surface. A liquid with lower surface energy than the solid will spread out over a greater area, bonding to the surface. This phenomenon is a result of the minimization of interfacial energy. A solid surface with high energy will be covered with a liquid because this interface will lower its free energy.

Therefore, by controlling the surface tension or surface energy of an ink or the surface on which it spreads, one can affect its affinity to a substrate. It is possible to make the ink ‘sticky’ or ‘non-sticky’, thus either adhering to the substrate or remaining on the carrying medium, such as, for example a printing drum or a printing plate.

### SUMMARY OF THE INVENTION

The direct printing device of this invention is based on modifying the properties of the ink-to-substrate affinity during the printing cycle, thereby controlling ink transfer to the substrate.

Briefly, according to one aspect of the present invention a printing apparatus for direct printing comprises an image bearing printing surface that comprises a plurality of cells for storing ink; a means for loading ink into the cells; a means for imaging direction on a substrate by affecting ink properties in a first group of cells to form ink affinity to the substrate; a means for unloading ink by affecting ink properties in a second group of cells to nullify ink affinity to the substrate; and a means for collecting the unloaded ink from the second group of cells.

In one embodiment of the present invention the printing surface of the direct printing device comprises a plurality of cavities. Each cavity is designed to store sufficient ink, to print on a specified area of a substrate. The ink is loaded on the printing surface by, for example, an anilox roller. After being loaded, the ink will be modified to change the ink affinity to the substrate or to the printing surface. After the modification two forms of ink will coexist on the printing surface; an ink that will remain on the surface after imaging, and an ink that will transfer from the printing surface onto the substrate.

### BRIEF DESCRIPTION OF THE DRAWINGS

FIG. 1 is a schematic illustrating a printing surface containing a plurality of ink cells;

FIG. 2 is a schematic illustrating an ink cell structure coupled with a heating and cooling elements;

FIG. 3 is a schematic showing cell structure for use with heat shrinking ink;

FIG. 4 is a schematic showing a cell structure for use with UV ink;

FIG. 5 is a schematic showing an external control of UV ink affinity apparatus; and

FIG. 6 is a schematic view of a printing device according to the present invention, using a cooled drum and a laser printhead.

### DETAILED DESCRIPTION OF THE INVENTION

The present invention describes a direct printing device containing a fully inked surface where the ink is released from this surface in an imagewise manner by means of selective control. The present invention includes a number of configurations of printing directly on a substrate by modifying the properties of ink to substrate affinity during the printing cycle thereby controlling ink transfer to the substrate.

Definitions of terms used in the patent application:
Substrate—the final destination of the ink.
Printing surface—an active ink reservoir, with or without cavities to hold the ink. This surface is used to control and modify ink properties. In some of the embodiments, the ink will be modified on the printing surface externally by a printing head.

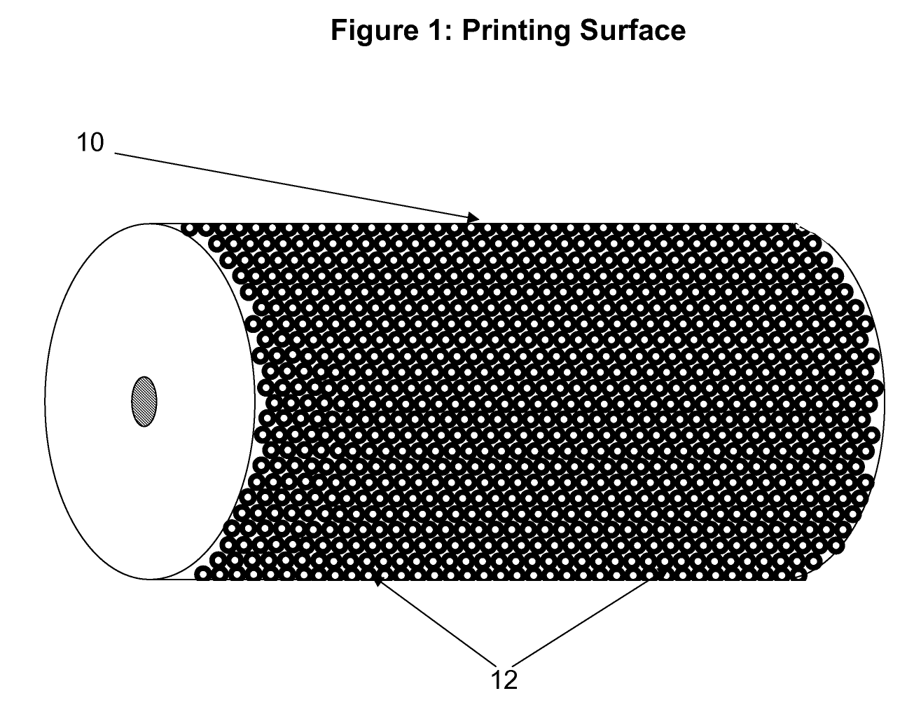

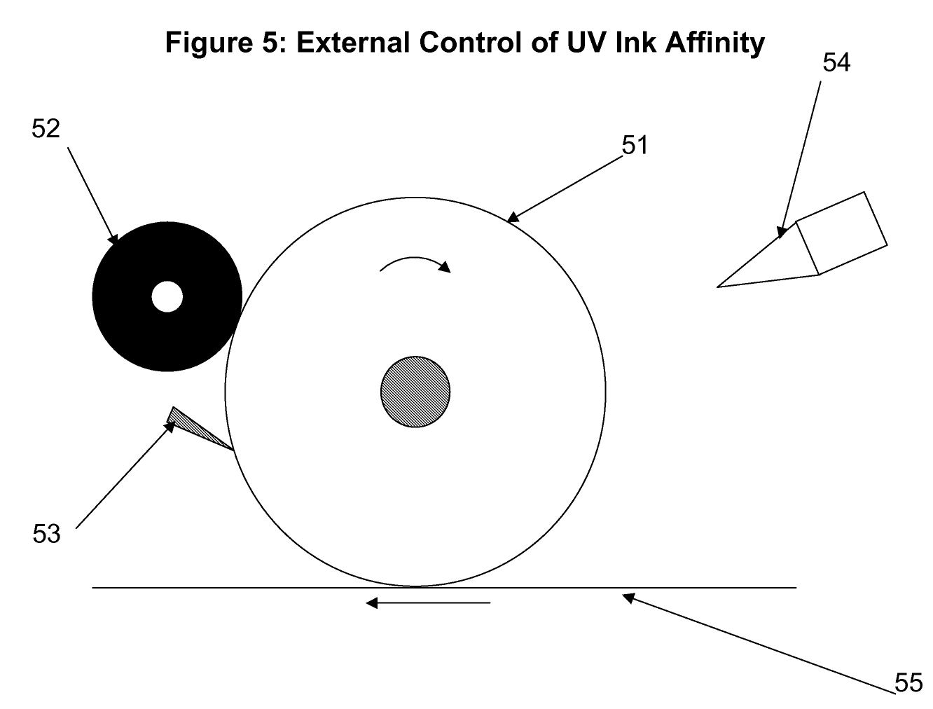

The ink is loaded for example, from an anilox roller 52 (shown in FIG. 5) into the ink cells 12 spread on printing surface 10, as illustrated in FIG. 1. After loading of the ink onto the printing surface 10, the ink properties will be modified selectively in some of the ink cells. The modification of the ink can be performed in a number of ways, and preferred methods are described below:
a) The ink viscosity is changed by changing its temperature. In one embodiment the ink temperature is lowered to increase viscosity or even to effect a phase change by freezing in the printing surface cells. The frozen or more viscous ink will not transfer to the substrate, while the liquid ink will transfer, thereby forming an image on the substrate.
b) In another embodiment, ink bonds to the surface of the carrying medium, such as a drum with cavities in the case of a rotary system at ambient temperature and does not transfer to the imaged surface. Heating the cells of portions to be imaged above a certain temperature will cause the ink to transfer to the substrate.
c) In another embodiment, a change in the ink volume causes ink with a higher volume to transfer to the substrate. Ink with a lower volume does not come into contact with the substrate.
d) In a further embodiment, a chemical change to the ink causes it to repel from the printing surface cells or to adhere to the substrate. This is in contrast to the printing plate used in an offset lithography where the printing plate is processed to have areas with the required affinity. The ink that has been modified to lower adhesion characteristics of the ink, will be transferred to the substrate. The ink that has not been modified will stay in the printing surface cells.

The ink that will form the image is transferred onto the substrate. The ink that remains on the printing surface must not be allowed to accumulate on it. The ink is reusable, and is returned to the ink reservoir and reverts to the original state in which it came out of the ink reservoir. In the embodiment wherein the ink is irreversibly modified, it will be removed from the system.

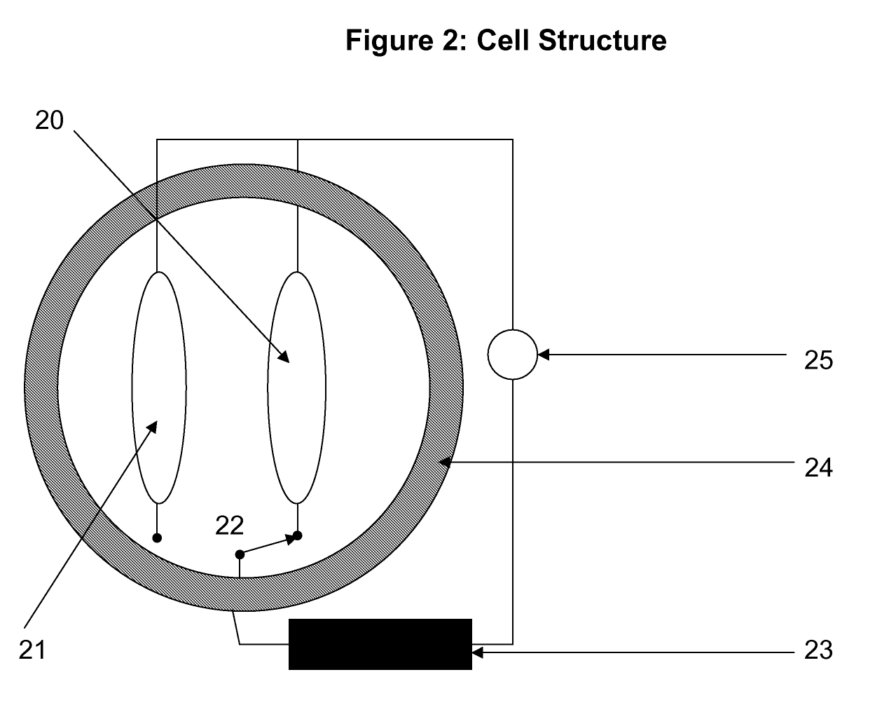

One embodiment of an ink modification apparatus is based on controlling ink cells 12 as illustrated in FIG. 1. Each cell is individually controllable and contains a micro electro thermal cooling device. FIG. 2 shows an ink modification apparatus attached to such an ink cell, based on a Peltier junction. According to this embodiment each ink cell 12 of FIG. 1, is associated with a cooling element 20 and a heating element 21 contained within heat sink 24. Elements 20 and 21 are switched on by switch 22, controlled by controller 23 and power supply 25.

The ink is loaded into the ink cells 12 on the printing surface 10 in a liquid form. The cells containing the ink that will not transfer to the substrate are then cooled by switching on the cooling elements 20, and the ink contained in those cells gains viscosity or freezes. The printing surface then contacts an intermediate blanket or the substrate, for example paper, and transfers the ink that is still liquid onto it. The frozen ink that remains on the drum is removed or melted to prevent buildup of high viscosity or frozen material. The heating elements 21 are turned on selectively to melt the ink. Heating and cooling elements are turned off before new ink is loaded again. The heating elements in each cell may be replaced by a single heating element that can heat many cells at once. The cleaning of the cells from frozen ink does not have to be controlled individually in each cell, but can be executed collectively to many cells at once with a single heating device. It should be noted that the driving force behind the ink property modifications is the change in temperature and not necessarily the absolute temperature.

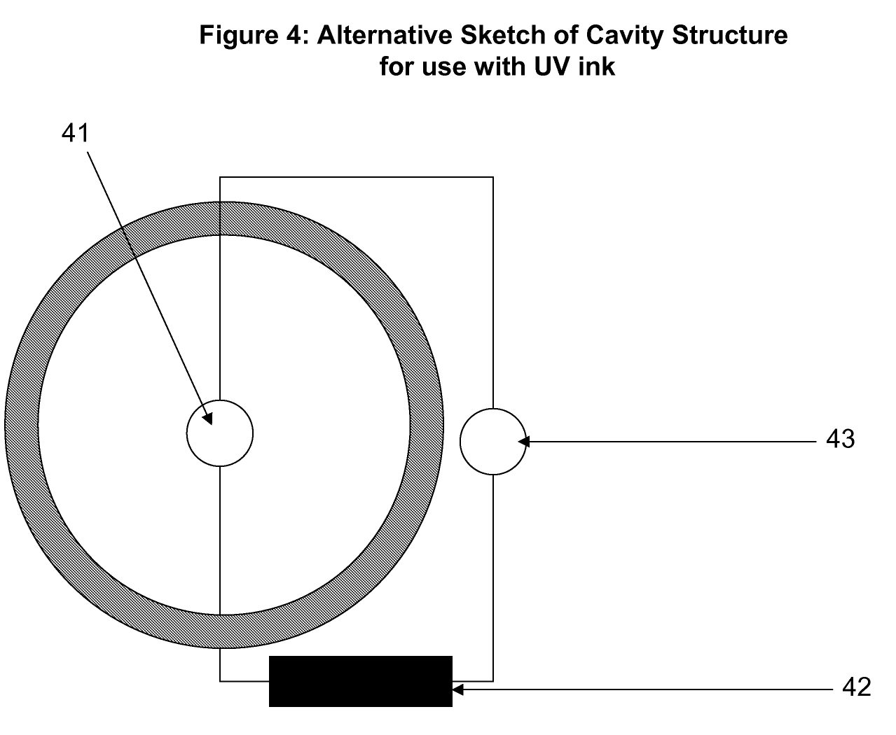

In another embodiment, a special ink containing a UV sensitive material that controls the inks affinity to the substrate or to the printing surface is used. Such an ink can be a UV curable ink, such as http://www.labelandnarrowweb.com/bg/category/Consumables/Inks/UV%20Flex o%20Ink. The printing surface contains a plurality of ink cells 12, as illustrated in FIG. 1. FIG. 4 illustrates an UV controlled cell; each cell contains an individually controlled UV LED 41 controller 42 and power supply 43. Once the ink is loaded on the printing surface, the UV LEDS are turned on to modify the sensitive material in the ink. The ink that has the higher affinity to the substrate is transferred to it, and the ink with the lower affinity is either returned to the printing system if it is still usable, or discarded. With UV curable inks, the UV LED 41 will cure the ink in the cell, and only the uncured ink will transfer to the substrate. The cured ink will be removed from the printing surface before each printing cycle, possibly by air pressure as described below. The transferred ink will be cured later by UV lamps further down the printing line.

The ink properties can also be controlled externally to the printing surface 51, as shown in FIG. 5. The UV ink is controlled by an external UV projection or laser head 54 which exposes the ink prior to its contact with the substrate 55. The excess ink is removed with a doctor blade 53 and the ink is loaded to the printing surface again by a device such as an anilox roller 52.

In another embodiment for ink modification, an ink containing a ferromagnetic material is used, such as http://www.maxmax.com/aMagneticInk.asp. The printing surface is covered with ink cells containing micro electromagnets or magnetic whiskers. The electromagnets in the ink cells are controlled individually. The affinity of the ink to the printing surface is controlled by the electromagnet within each cell. Turning the electromagnets on may change the ink properties by shrinking the ink in the cell or by changing the surface properties of the ink anisotropically, if the ink contains liquid crystals.

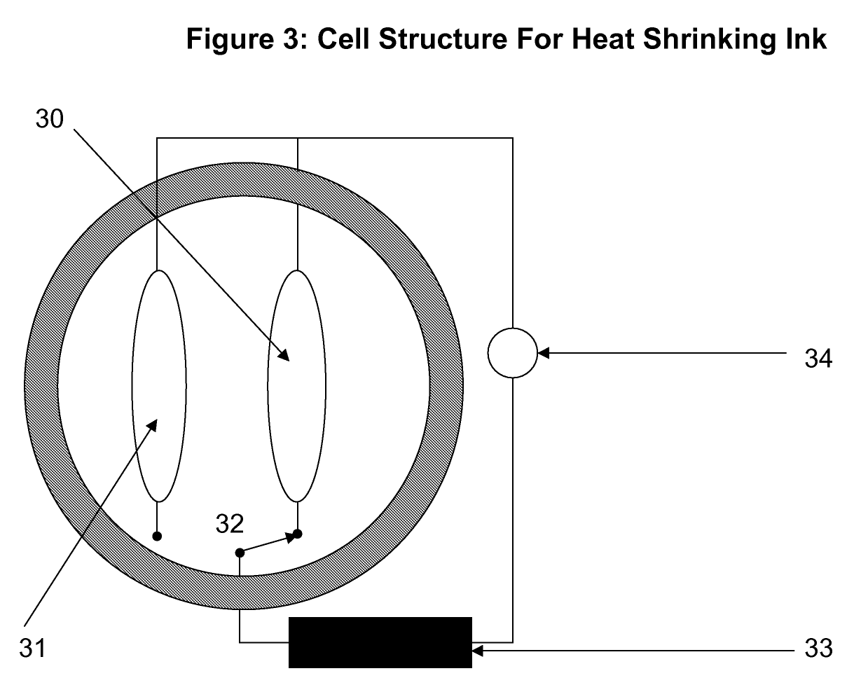

In another embodiment for ink modification purposes, a special ink that shrinks under heat is used. According to this embodiment each ink cell as is shown in FIG. 3 has a heating element 30 and an air pressure gate 31. The heating element is powered by power supply 34 and is individually controlled by controller 33. The air pressure gate 31 in each cell is used for removal of unused ink. Switch 32 switches between heating element 30 and air pressure gate 31 as is requested by controller 33. The ink is loaded into the ink cells and it can be either transferred to the substrate or heated. The heated ink will shrink into the ink cell and not get in contact with the substrate. An example for such ink can be a heat curable prepolymer which crosslinks and shrinks during polymerization. All the ink cells that have already passed over the substrate 55 are exposed to higher internal air pressure to remove the excess shrunken ink out of the cell. The air pressure in each of the cells does not have to be individually controlled; the air pressure can be switched in a plurality of ink cells, for excess ink removal.

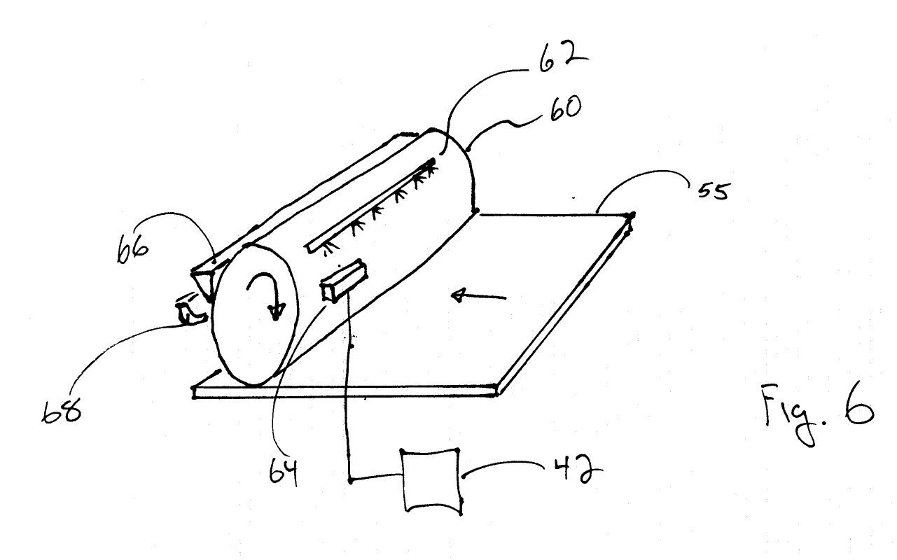

An embodiment of the present invention shown in FIG. 6 uses a cooled drum 60. An applicator 62 applies ink to a surface of the drum which is cooled or optionally frozen on the surface of the drum. A printhead 64 applies energy in an imagewise fashion to the surface of the drum either unfreezing or heating ink in the area to be transferred to substrate 55. Image information is provided to printhead 64 by controller 42. Printhead 64 translates in an axial direction across drum 62 in a manner which is well known in the printing art. Printhead 64 in one embodiment includes a plurality of laser printheads. Printhead 64 may also extend across the entire length, in an axial direction, of drum 60.

In operation a substrate 55, for example paper, moves leftward as shown by the arrow. Ink that has been heated by printhead 64 is transferred to the substrate 55 as it moves under drum 60. Ink which has not been transferred to substrate 55 is removed from the drum surface. In the example shown a scraper 66 removes ink from the surface of the drum 60 which is collected in reservoir 68. Other methods of removal of the ink may be used. Other variations of the embodiment shown in FIG. 6 are feasible, for example heating a portion of the drum after transferring of the image and cooling only a section of drum 60 after ink has been sprayed by applicator 62.

### PARTS LIST

10 printing surface
12 ink cells
20 cooling element
   21 heating element
22 switch
23 controller
24 heat sink
25 power supply
30 heating element
31 air pressure gate
32 switch
33 controller
34 power supply
41 UV led
42 controller
43 power supply
51 printing surface
52 anilox roller
53 blade
54 UV projection head
55 substrate
60 drum
62 applicator
64 printhead
66 scraper
68 reservoir

1. A printing apparatus for direct printing, comprising:
an image bearing printing surface comprising a plurality of cells for storing ink;
means for loading ink into said cells;
means for printing directly or by use of a blanket to a substrate by affecting ink properties in a first group of said cells to form ink affinity to the substrate or blanket;
means for unloading ink by affecting ink properties in a second group of said cells to nullify ink affinity to the substrate; and
means for collecting the unloaded ink from the second group of cells.

2. The printing apparatus of claim 1 wherein the printing surface is a rotating printing drum.

3. The printing apparatus of claim 1 wherein means for loading are implemented by an anilox roller.

4. The printing apparatus of claim 1 wherein ink affinity to the substrate is controlled by micro electro thermal devices coupled with the ink cells.

5. The printing apparatus of claim 1 wherein ink affinity to substrate is controlled by applying ultra violet (UV), laser (IR (infrared) and violet), or spatial light modulator (SLM) light on the ink cells.

6. The printing apparatus of claim 1 wherein ink affinity to substrate is controlled by micro electro magnets coupled with the ink cells.

7. The printing apparatus of claim 1 wherein ink affinity to substrate is controlled by micro thermal devices.

8. The printing apparatus of claim 1 wherein the ink comprises UV sensitive material.

9. The printing apparatus of claim 1 wherein the ink is ferromagnetic ink.

10. The printing apparatus of claim 1 wherein the ink shrinks when heat is applied.

11. The printing apparatus of claim 1 wherein ink properties are affected by changing ink viscosity using thermal means.

12. A method for printing comprising:
transferring ink to a surface on a drum;
altering properties of a portion of the ink in an image wise fashion to create an image on the drum; and
transferring the image to a substrate.

13. The method of claim 12 comprising:
removing unaltered ink from the surface of the drum.

14. The method of claim 13 comprising:
recycling the unaltered ink.

15. The method of claim 12 comprising:
after transferring the ink to a surface of the drum, cooling the ink.

16. The method of claim 15 wherein the step of altering properties comprises heating the portion of the ink in an image wise fashion.

17. The method of claim 13 wherein the step of removing unaltered ink comprises scraping the ink from the surface of the drum.

18. A printing apparatus comprising:
a printing surface;
a roller for loading ink into the printing surface; and
an imaging apparatus for altering ink properties in an image wise fashion.

19. A printing apparatus as in claim 18 wherein the altered ink image is transferred to a substrate.

20. A printing apparatus as in claim 19 wherein unaltered ink is removed from the printing surface after the images transferred to the substrate.
